(19) United States
(12) Patent Application Publication
(10) Pub. No.: US 2025/0016264 A1
(43) Pub. Date: Jan. 9, 2025

(54) MULTI-USER AUDIO SIGNAL PROCESSOR FOR IMITATING A FEEDBACK SIDETONE

(71) Applicant: SKYWORKS SOLUTIONS, INC., Irvine, CA (US)

(72) Inventor: Shawn William Scarlett, San Francisco, CA (US)

(21) Appl. No.: 18/761,478

(22) Filed: Jul. 2, 2024

Related U.S. Application Data
(60) Provisional application No. 63/524,975, filed on Jul. 5, 2023.
(60) Provisional application No. 63/524,977, filed on Jul. 5, 2023.

(51) Int. Cl. H04M 3/00; G10L 21/0208; G10L 21/034; G10L 21/0364

(52) U.S. Cl. CPC H04M 3/002; G10L 21/0208; G10L 21/034; G10L 21/0364; G10L 2021/02082

(57) ABSTRACT

An audio processor for generating a non-delayed sidetone for a user, the audio processor including an input for receiving a playback signal, the playback signal including respective delayed audio signals from one or more users mixed together as the playback signal, the one or more users including a first user and the mixed audio signal from the first user being a delayed input audio signal; a signal remover configured to generate a first processed signal by removing the delayed audio signal for the first user from the playback signal; and a signal mixer coupled to the signal remover, the signal mixer configured to: generate a second processed signal by mixing the first processed signal with a non-delayed input audio signal from the first user, and output the second processed signal, the non-delayed input audio signal acting as a sidetone for the first user.

### CROSS-REFERENCE TO RELATED APPLICATIONS

This application claims priority under 35 U.S.C. § 119 (e) to U.S. Provisional Patent Application Ser. No. 63/524,975, titled “MULTI-USER AUDIO SIGNAL PROCESSOR FOR IMITATING A FEEDBACK SIDETONE,” filed Jul. 5, 2023, and to U.S. Provisional Patent Application Ser. No. 63/524,977, titled “MULTI-USER AUDIO SIGNAL HEADSET FOR IMITATING A FEEDBACK SIDETONE,” filed Jul. 5, 2023, the entire contents of which are incorporated herein by reference for all purposes.

### BACKGROUND

### Field

Aspects and embodiments of the present disclosure relate to devices, systems and methods for generating a non-delayed sidetone.

### Description of the Related Technology

In a wireless audio system involving one or more users, a resulting audio processing and transmission can introduce latency. This may lead to a problem that the one or more users of the audio system can hear their own voices while talking, such as an echo. Such latency is not necessarily due to a wireless transmission and can be created by downstream processing or signal conversion.

FIG. 1 shows a basic audio processing system 100 for a user. When the user speaks, the user's voice is captured by a microphone 110 as an input audio signal 101. The captured input audio signal 101 is then conducted to a recording system 120 for audio processing and transmitted back to the user through a speaker 130. During the transmission and/or processing, there is inherent delay in the transmitted input audio signal 101. Such delay may be caused anywhere along the transmission path from the microphone 110 to the speaker 130, such as in the recording system 120, which could be a cumulative effect. For example, a delayed input audio signal is denoted as audio signal 102 (shown as a dotted line in FIG. 1). At the recording system 120, a signal mixer 121 in the recording system 120 is configured to mix the delayed signal 102 with a playback of a recorded audio signal 103 from the user. The mixed signal is denoted as a processed signal 104. The processed audio signal 104 (mixed with the delayed signal 102) is subsequently returned back to the user through the speaker 130 where the user can hear his/her own voice as a feedback.

However, the delayed audio signal 102 in the processed signal 104 may cause issues for the user that is listening to his/her own voice while talking, such as an echo. This may cause difficulty in speaking or concentration when the delay is significant.

Conventionally, such a problem is solved by inserting a local sidetone from the input audio signal to the feedback signal before any delay is incurred. FIG. 2 shows a modified audio processing system 200 using such a method. Similar to the configuration shown in FIG. 1, FIG. 2 shows a user whose voice is captured by a microphone 210 and input to the processing system as an audio signal 201a. The input audio signal 201a is then conducted to a recording system 220 for audio processing, and output to a speaker 230 for the user to listen his/her own voice. Instead of using a mixer 221 to mix a delayed input audio signal 202 with the playback of the recorded audio signal 203 from the user, the recording system 220 directly outputs the recorded audio signal 203. A second mixer 222 is introduced which is coupled between the output of the recording system 220 and the speaker 230. The second mixer 222 is configured to mix a local input signal 201b before any delay is incurred and the playback signal 203 and to output a processed signal 204 through the speaker 230 for the user.

This method has an advantage of preventing latency issues and gives the user feedback of their voice. This is a well-known technique that has been a standard method in phone communications for decades. However, it has a distinct disadvantage of requiring the playback signal to contain only the far-side information. This is acceptable for many applications where the users do not need to have information about an end mix of the recorded audio signal and a relative level of their own voice in the playback content. In point-to-point communications like a telephone system, there is no need to mix the signals since each end point receives only the other system's signal. However, when the one or more users in the audio system require a feedback of their own voices in the end mix, it is desirable to process the delayed audio signal to imitate a non-delayed audio signal as an effective feedback to the users.

### SUMMARY

According to a first aspect there is provided an audio processor for generating a non-delayed sidetone for a user. The audio processor comprises: an input for receiving a playback signal, the playback signal including respective delayed audio signals from one or more users mixed together as the playback signal, the one or more users including a first user and the mixed audio signal from the first user being a delayed input audio signal; a signal remover configured to generate a first processed signal by removing the delayed audio signal for the first user from the playback signal; and a signal mixer coupled to the signal remover, the signal mixer configured to generate a second processed signal by mixing the first processed signal with a non-delayed input audio signal from the first user, and output the second processed signal, the non-delayed input audio signal acting as a sidetone for the first user.

In one example, the audio processor further comprises a measuring unit coupled to the signal remover. The measuring unit is configured to determine an audio feature of the delayed audio signal of each user relative to the playback audio signal or relative to the non-delayed input audio signal from each user.

In one example, the audio processor further comprises a first amplifier, wherein a first input of the amplifier is coupled to the measuring unit and a second input of the amplifier is coupled to the non-delayed input audio signal from each user, and an output of the amplifier is coupled to the signal mixer such that the audio feature of the non-delayed input audio signal is adjusted based on the relative level with respect to the playback audio signal.

In one example, the audio feature is a volume or a frequency of the delayed audio signal.

In one example, the audio processor further comprises a microphone coupled to the audio processor, the microphone being configured to input audio signals from the respective user.

In one example, the audio processor further comprises a speaker coupled to the audio processor, the speaker being configured to output the second processed audio signal to the respective user.

In one example, the audio processor further comprises an analog-to-digital converter, ADC, coupled to the microphone.

In one example, the audio processor further comprises a digital-to-analog converter, DAC, coupled to the speaker.

According to a second aspect there is provided an audio processing system for generating a non-delayed sidetone for a first user of a plurality of users. The audio processor comprises: a first audio processor according to the first aspect; and a second audio processor for generating a non-delayed sidetone for a second user of the plurality of users, the second audio processor comprising a second input for receiving a second playback signal, the playback signal including respective delayed audio signals from the plurality of users mixed together as the playback signal and the mixed audio signal from the second user being a respective delayed input audio signal; a second signal remover configured to generate a third processed signal by removing the delayed audio signal for the second user from the second playback signal; and a second signal mixer coupled to the second signal remover, the second signal mixer configured to: generate a fourth processed signal by mixing the third processed signal with a non-delayed input audio signal from the second user, and output the fourth processed signal, the non-delayed input audio signal acting as a sidetone for the second user.

According to a third aspect there is provided, a computer-implemented device for generating a non-delayed sidetone for a user. The device comprises: an input for receiving a playback signal, the playback signal including respective delayed audio signals from a plurality of users mixed together as the playback signal, the plurality of users including a first user and the mixed audio signal from the first user being a delayed input audio signal; a signal remover configured to generate a first processed signal by removing the delayed audio signal for the first user from the playback signal; and a signal mixer coupled to the signal remover, the signal mixer configured to generate a second processed signal by mixing the first processed signal with a non-delayed input audio signal from the first user, and output the second processed signal, the non-delayed input audio signal acting as a sidetone for the first user.

According to a fourth aspect there is provided a computer-implemented system comprising: the computer-implemented device according to the third aspect; and a recording device coupled to the computer-implemented device, the recording device is configured to generate the playback signal inputting to the computer-implemented device.

In one example, the computer-implemented system further comprises a second amplifier in the recording device for adjusting an audio feature of the delayed input audio signal in the mixed playback signal.

According to a fifth aspect there is provided an audio processing method for generating a non-delayed sidetone for a user. The audio processing method comprises receiving a playback signal, the playback signal including respective delayed audio signals from one or more users mixed together as the playback signal, the plurality of users including a first user and the mixed audio signal from the first user being a delayed input audio signal; generating, by a signal remover, a first processed signal by removing the delayed audio signal for the first user from the playback signal; generating, by a signal mixer, a second processed signal by mixing the first processed signal with a non-delayed input audio signal from the first user; and outputting, by the signal mixer, the second processed signal, the non-delayed input audio signal acting as a sidetone for the first user.

In one example, the method further comprises determining, by a measuring unit, an audio feature of the delayed audio signal of each user relative to the playback audio signal or relative to the non-delayed input audio signal from each user.

In one example, the method further comprises adjusting, by a first amplifier, an audio feature of the non-delayed input audio signal based on a relative level to the playback signal, wherein a first input of the first amplifier is coupled to the measuring unit and a second input of the first amplifier is coupled to the non-delayed input audio signal from each user, and an output of the first amplifier is coupled to the signal mixer.

In one example, the audio feature is a volume or a frequency of the delayed audio signal.

In one example, the method further comprises inputting, by a microphone, an input audio signal from each user.

In one example, the method further comprises outputting, by a speaker, the second processed audio signal to each respective user.

In one example, the method further comprises coupling an analog-to-digital converter to the microphone.

In one example, the method further comprises coupling a digital-to-analog converter to the speaker.

In one example, the method further comprises generating, by a recording device, the playback signal.

In one example, the method further comprises adjusting, by a second amplifier, an audio feature of the delayed input audio signal in the mixed playback signal.

Still other aspects, embodiments, and advantages of these exemplary aspects and embodiments are discussed in detail below. Embodiments disclosed herein may be combined with other embodiments in any manner consistent with at least one of the principles disclosed herein, and references to “an embodiment,” “some embodiments,” “an alternate embodiment,” “various embodiments,” “one embodiment” or the like are not necessarily mutually exclusive and are intended to indicate that a particular feature, structure, or characteristic described may be included in at least one embodiment. The appearances of such terms herein are not necessarily all referring to the same embodiment.

### BRIEF DESCRIPTION OF THE DRAWINGS

Various aspects of at least one embodiment are discussed below with reference to the accompanying figures, which are not intended to be drawn to scale. The figures are included to provide illustration and a further understanding of the various aspects and embodiments, and are incorporated in and constitute a part of this specification, but are not intended as a definition of the limits of the invention. In the figures, each identical or nearly identical component that is illustrated in various figures is represented by a like numeral. For purposes of clarity, not every component may be labeled in every figure. In the figures:

FIG. 1 is a schematic block diagram of an audio processing system 100 that has an inherent delay in transmission;

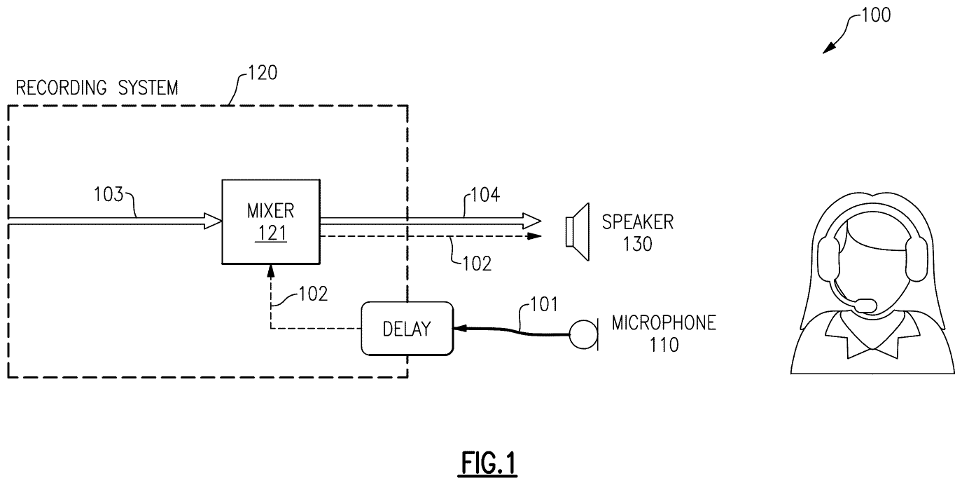

FIG. 2 is a schematic block diagram of a modified audio processing system 200 that inserts a sidetone;

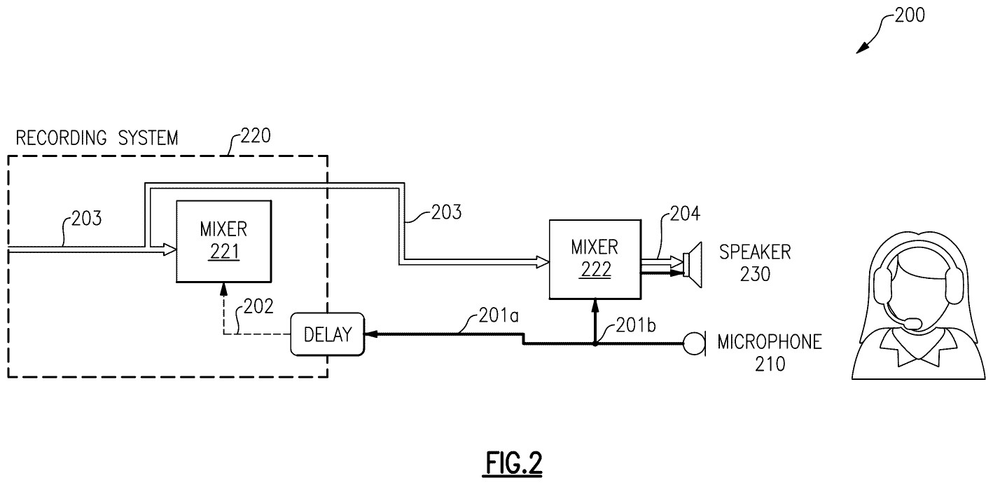

FIG. 3 is a schematic block diagram of an audio processing system 300 including a processor 340 according to aspects of the present disclosure;

FIG. 4 is a detailed diagram of an audio processing system 400 including an audio processor 440 comprising a signal remover 441 and a signal mixer 442 according to aspects of the present disclosure;

FIG. 5 is a detailed diagram of an audio processing system 500 including an audio processor 540 comprising a signal remover 541, a mixer 542, a measuring unit 543 and an amplifier 544 according to aspects of the present disclosure; and

FIG. 6 is a detailed diagram of an audio processing system 600 including three audio processors for three different users according to aspects of the present disclosure.

### DETAILED DESCRIPTION

It is to be appreciated that embodiments of the methods and apparatuses discussed herein are not limited in application to the details of construction and the arrangement of components set forth in the following description or illustrated in the accompanying drawings. The methods and apparatuses are capable of implementation in other embodiments and of being practiced or of being carried out in various ways. Examples of specific implementations are provided herein for illustrative purposes only and are not intended to be limiting. Also, the phraseology and terminology used herein is for the purpose of description and should not be regarded as limiting. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

The present disclosure relates to wireless communication systems or audio or video recording systems or audio streaming platforms. The proposed solution is to remove the delayed voice from the return signal. This could be accomplished by using approaches that are used in standard Acoustic Echo Cancellation (AEC) algorithms. AEC solutions are well known and available which are designed to remove echoes, reverberation, or any unwanted added sounds from a signal that passes through an acoustic space. After the delayed signal is removed, the voice signal may be re-introduced from the local signal before any delay is incurred. This system would effectively pull-in the user's voice to work as an effective side-tone and give productive feedback while talking, improving comfort and quality.

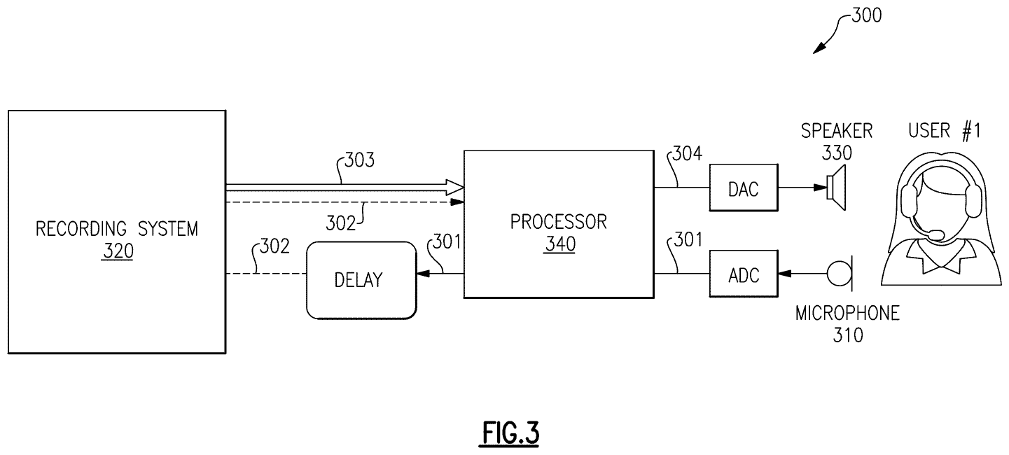

FIG. 3 is a schematic depiction of an exemplary audio processing system 300 according to the present disclosure, showing a user (denoted as user #1) whose voice may be captured by a microphone 310, recorded at a recording system 320, and returned back to the user through a speaker 330. In some embodiments, the audio processing system 300 may be operated in a multi-user environment, wherein the recording system 320 may be shared by more than one user to record audio signals from multiple users and output a mix of the recorded audio signals as a playback signal to each of the multiple users. Although it is not entirely shown in FIG. 3, the multiple users may include user #1, user #2, user #3 . . . and user #N, wherein each user of the multiple users has a set of microphones and speakers. FIG. 3 shows only a processing module for the user #1 in the multi-user environment. In some embodiments, the recording system 320 may be a recording device or a recording platform shared through wired or wireless network.

The captured voice from user #1 may be processed to an input audio signal 301 by an analog-to-digital converter (ADC) for a set of processing and converted back through a digital-to-analog converter (DAC). During the transmission and processing of the user's voice, a delay may occur due to wireless communication, downstream processing or signal conversion. As shown in FIG. 3, a delayed audio signal 302 may be transmitted to the recording system 320. The recording system 320 may mix the delayed signal 302 with a recorded audio signal 303 from the user and output a combined signal to the user. The recorded audio signal 303 may be a mix of recorded audio signals from multiple users who are sharing the recording system. In order to solve the delay problem, a processor 340 for user #1 may be introduced to the audio processing system 300 which may be coupled to both the microphone 310 and the speaker 330 as shown in FIG. 3. In some embodiments, although it is not shown in FIG. 3, the processor 340 may be introduced to each of the processing modules for each user of the multiple users in the audio processing system 300. The processor 340 for user #1 may be configured to process and control the original audio signal 301 after being input to the system 300, and to process and control the combined audio signal before being outputting to the user. In detail, the processor 340 may be configured to remove the delayed audio signal 303 from the combined signal at the output of the recording system 320. The processor 340 may also be configured to insert a non-delayed audio signal to the processed audio signal to be returned back to the user, so that the user can hear his/her own voice relative to other users in the context of the recorded audio signal of multiple users.

The configuration shown in FIG. 3 not only enables the non-delayed audio signal of the user to be inserted as a sidetone, but also enables such sidetone to be served as an effective feedback for the user to obtain relative levels of their voice in an end mix of multiple users whose voices have all been recorded and mixed.

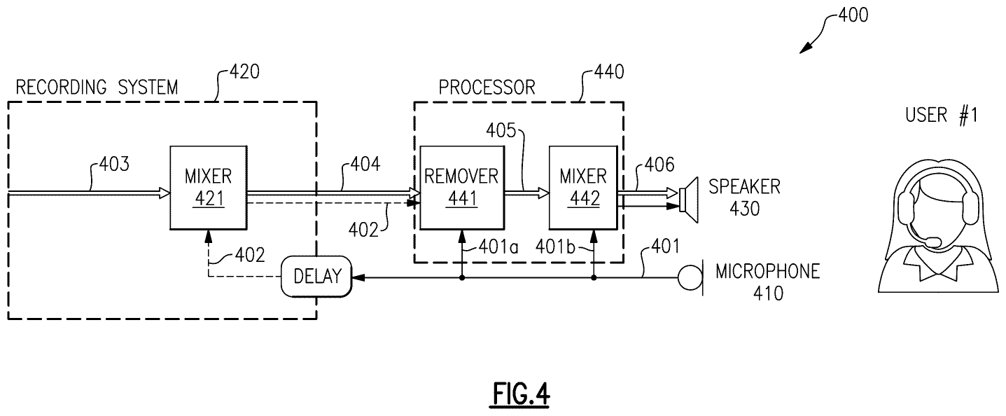

FIG. 4 is a schematic depiction of an exemplary audio processing system 400 showing a more detailed configuration of the audio processing system 400 for a user #1 based on the structure shown in FIG. 3. The voice of user #1 may be captured by a microphone 410, recorded at a recording system 420, and returned back to the user through a speaker 430. In some embodiments, similar to the audio processing system 300 in FIG. 3, the audio processing system 400 may be operated in a multi-user environment, wherein the recording system 420 may be shared by more than one user to record audio signals from multiple users and output a mix of the recorded audio signals as a playback signal to each of the multiple users. Although it is not entirely shown in FIG. 4, the multiple users may include user #1, user #2, user #3 . . . and user #N, wherein each user of the multiple users has a set of microphones and speakers. FIG. 4 shows only a processing module for the user #1 in the multi-user environment.

The captured voice from user #1 may be converted to input audio signals 401a and 401b by an analog-to-digital converter (ADC) for processing and converted back through a digital-to-analog converter (DAC) at the end of processing before being output to the speaker 430. During the transmission and processing of the user's voice, a delay may occur due to wireless communication, downstream processing or signal conversion. As shown in FIG. 4, a delayed audio signal 402 may be transmitted to the recording system 420. The recording system 420 may mix the delayed signal 402 with a recorded audio signal 403 from the user and output a combined signal to the user. The recorded audio signal 403 may be a mix of recorded audio signals from multiple users who are sharing the recording system. In order to solve the delay problem, a processor 440 for user #1 may be introduced to the audio processing system 400 which may be coupled to both the microphone 410 and the speaker 430 as shown in FIG. 4. In some embodiments, although it is not shown in FIG. 4, the processor 440 may be introduced to each of the processing modules for each user of the multiple users in the audio processing system 400. The processor 440 for user #1 may include a signal remover 441 and a signal mixer 442. The signal remover 441 may be coupled to an output of the recording system 420 and the mixer 442; and the signal mixer 442 may be coupled to the speaker 430 and the signal remover 441. With such configuration, the processor 440 may process and control the original audio signal 401 after being input to the system 400, and may process and control the combined audio signal before being outputting to the user. A delay of the input audio signal may be caused anywhere along the transmission path from the microphone 410 to the speaker 430, which is to be processed by the processor 440.

In detail, an original audio signal 401 of the voice of user #1 may be input by the microphone 410. During the transmission, a delayed audio signal 402 may be input to the recording system 420 which may be mixed with a mix signal 403 by a mixer 421 in the recording system 420. In some embodiments, the mix signal 403 may be a live-recorded or live-streamed signal mixing all audio signals from the multiple users sharing the recording system 420. The recording system 420 may then output a first processed signal 404 which is a mix of the mix signal and the delayed signal 402. The processed signal 404 may then be processed by the signal remover 441 of the processor 440. The signal remover 441 may be configured to remove the delayed audio signal from the first processed signal 404 and as a result, generate a second processed signal 405. In detail, as shown in FIG. 4, two audio signals may be input to the signal remover 441, representing the delayed audio signal 402 (dotted line) and the non-delayed audio signal 401a from the original audio signal (solid line). The signal remover 441 may be configured to remove the delayed audio signal 402 with respect to the non-delayed audio signal 401a. The non-delayed audio signal 401a may serve as a reference that may be taken by the signal remover 441, such that the signal remover 441 may locate the correct corresponding delayed audio signal 402 in the first processed signal 404. This configuration of the signal remover 441 is known as an “echo canceller”. Once the delayed audio signal 402 is recognized, it may be removed by subtracting it from the received first processed signal 404. In some embodiments, the signal remover 441 may be replaced by any algorithm, such as an AI based noise reduction algorithm, that could remove any audio signals.

Before outputting a resultant audio signal to the user, the removed delayed audio signal 402 may be added back to the second processed signal 405 as a non-delayed audio signal. This means that the delayed audio signal 402 may be processed such that it is replaced by a non-delayed audio signal in the resultant audio signal. This may be achieved by using the signal mixer 442. The signal mixer 442 may be configured to mix the second processed signal 405 with a non-delayed original audio signal 401b and as a result, generate a third processed signal 406 to be output to the user through the speaker 430.

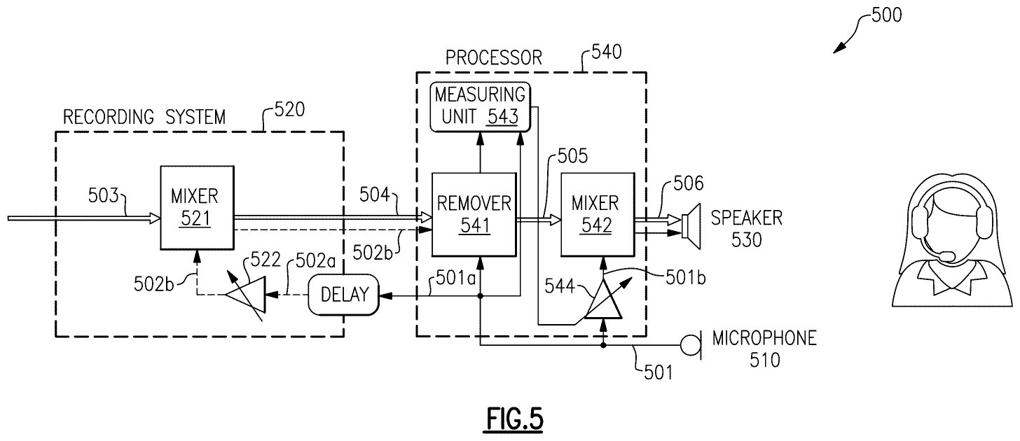

FIG. 5 is a schematic depiction of an exemplary audio processing system 500 showing a more detailed configuration of the audio processing system 500 for a user #1 based on the elements shown in FIGS. 3 and 4. The voice of user #1 may be captured by a microphone 510, recorded at a recording system 520, and returned back to the user through a speaker 530. In some embodiments, similar to the audio processing systems 300 and 400 in FIGS. 3 and 4, the audio processing system 500 may be operated in a multi-user environment, wherein the recording system 520 may be shared by more than one user to record audio signals from multiple users and output a mix of the recorded audio signals as a playback signal to each of the multiple users. Although it is not entirely shown in FIG. 5, the multiple users may include user #1, user #2, user #3 . . . and user #N, wherein each user of the multiple users has a set of microphone 510 and speaker 520. FIG. 5 shows only a processing module for the user #1 in the multi-user environment.

The captured voice from user #1 may be converted to an input audio signal by an analog-to-digital converter (ADC) for processing and converted back through a digital-to-analog converter (DAC) at the end of processing before being output to the speaker 530. During the transmission and processing of the user's voice, a delay may occur due to wireless communication, downstream processing or signal conversion. Such delay may be caused anywhere along the transmission path from the microphone 510 to the speaker 530. As shown in FIG. 5, a delayed audio signal 502a may be transmitted to the recording system 520. The recording system 520 may mix the delayed signal 502a with a recorded audio signal 503 from the user and output a combined signal to the user. The recorded audio signal 503 may be a mix of recorded audio signals from multiple users who are sharing the recording system. In order to solve the delay problem, a processor 540 for user #1 may be introduced to the audio processing system 500 which may be coupled to both the microphone 510 and the speaker 530 as shown in FIG. 5. In some embodiments, although it is not shown in FIG. 5, the processor 540 may be introduced to each of the processing module for each user of the multiple users in the audio processing system 500. The processor 540 for user #1 may include a signal remover 541 and a signal mixer 542. The signal remover 541 may be coupled to an output of the recording system 520 and the mixer 542; and the signal mixer 542 may be coupled to the speaker 530 and the signal remover 541. With such configuration, the processor 540 may process and control the original audio signal after being input to the system 500, and the combined audio signal before being output to the user.

In detail, an original audio signal 501 may be input by the microphone 510. During the transmission, a delayed audio signal 502a may be input to the recording system 520 which may be mixed with a mix signal 503 by a mixer 521 in the recording system 520. In some embodiments, an amplifier 522 may be inserted before inputting the delayed audio signal 502a to the recording system 520. The amplifier 522 may be configured to control a gain of the delayed audio signal 502a which may be changed to a delayed audio signal 502b. This delayed audio signal 502b after adjustment by the amplifier 522 may then be input to the recording system 520 which may be then mixed with a mix signal 503 by a mixer 521 in the recording system 520. In some embodiments, the mix signal 503 may be a live-recorded or live-streamed signal mixing all audio signals from the multiple users sharing the recording system 520. The recording system 520 may then output a first processed signal 504 which is a mix of the mix signal 503 and the delayed signal 502b. The processed signal 504 may then be processed by the signal remover 541 of the processor 540.

The signal remover 541 may be configured to remove the delayed audio signal from the first processed signal 504 and as a result, generate a second processed signal 505. In detail, as shown in FIG. 5 at block 541, two audio signals may be input to the signal remover 541, representing the delayed audio signal 502a, or 502b if processed by the amplifier 522 (dotted line), and the non-delayed audio signal 501a from the original audio signal (solid line). The signal remover 541 may be configured to remove the delayed audio signal 502a or 502b with respect to the non-delayed audio signal 501a. The non-delayed audio signal 501a may serve as a reference that may be taken by the signal remover 541, such that the signal remover 541 may locate the correct corresponding delayed audio signal 502 in the first processed signal 504. This configuration of the signal remover 541 is known as an “echo canceller”.

Before outputting a resultant audio signal to the user, a non-delayed audio signal 501b may be added back. This means that the delayed audio signal 502 may be processed such that it is replaced by a non-delayed audio signal in the resultant audio signal. This may be achieved by using the signal mixer 542. The signal mixer 542 may be configured to mix the second processed signal 505 with a non-delayed original audio signal 501b and as a result, generate a third processed signal 506 to be output to the user through the speaker 530.

In some embodiments, the signal remover 541 may be replaced by any algorithm, such as an Al based noise reduction algorithm, that could remove any audio signals. In addition to simply blocking the delayed audio signal in the processed signal, the processor 540 may also be configured to measure one or more parameters of the delayed audio signal.

In some embodiments, the processor 540 may include a measuring unit 543. The measuring unit 543 may be coupled to the signal remover 541 and may be configured to measure one or more parameters of the delayed audio signal. In some embodiments, the measured parameters may include the volume of the delayed signal or the frequency of the delayed signal. In some embodiments, the processor 540 may also include an adjustment circuit, such as an amplifier 544, between an input of the original audio signal 501 from user #1 and the signal mixer 542 as shown in FIG. 5. The amplifier 544 may be configured to have a first input coupled to the measuring unit 543, a second input coupled to the input of the original audio signal 501 and an output coupled to the signal mixer 542. With such configuration, the processor 540 may adjust the volume or frequency level of the original audio signal 501 through the amplifier 544 according to the measured volume or frequency level of the delayed audio signal at the measuring unit 543, rather than directly pulling-in the original audio signal 501. In some embodiments, the adjustment circuit may be configured to adjust the gain, frequency response or pitch of audio signals. The signal mixer 542 in the processor 540 may then be configured to mix the adjusted original audio signal 501b and the processed signal 505, and as a result, to generate a signal 506 to be returned back to the user #1 through the speaker 530. Therefore, an effective sidetone may be introduced that imitate the volume or frequency level of the user's voice in the mixed audio signal, which gives the user a feedback to how he/she sounds in the mixed audio from multiple users. This configuration would allow unlimited number of users to contribute to a mix without requiring a custom mix.

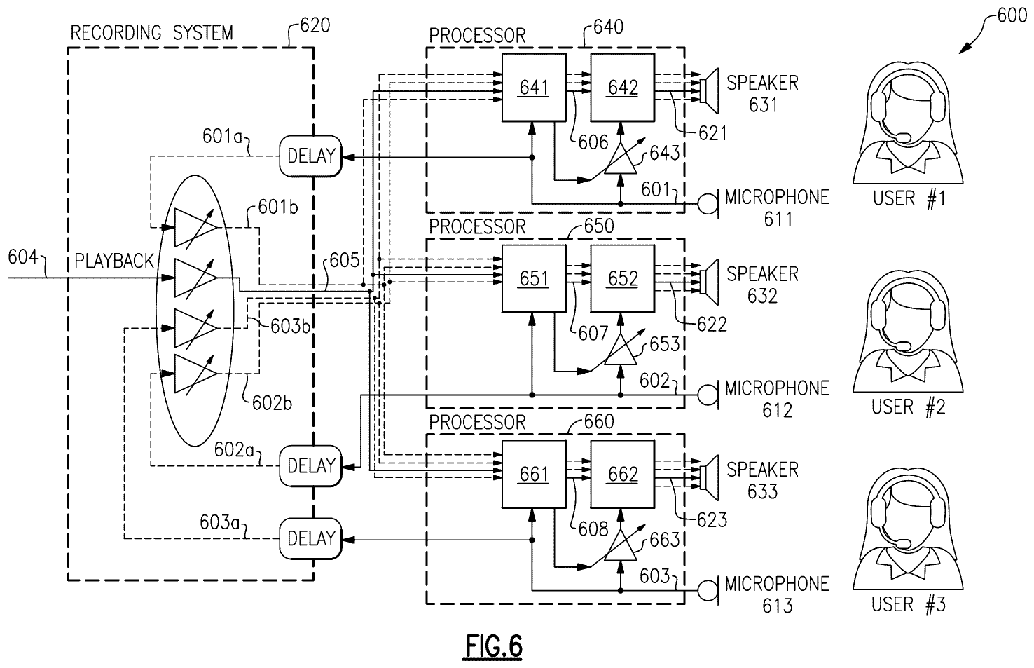

FIG. 6 is a schematic depiction of an exemplary multi-user audio processing system 600. Three users, namely user #1, user #2 and user #3, are shown in the processing system 600. Each user may have a set of microphone and speaker: microphone 611 and speaker 631 for user #1; microphone 612 and speaker 632 for user #2, and microphone 613 and speaker 633 for user #3, respectively. The three users (user #1, user #2 and user #3) may share a recording system 620. The voice of user #1 may be captured by the microphone 611 and returned back though the speaker 631; the voice of user #2 may be captured by the microphone 612 and returned back though the speaker 632; and the voice of user #3 may be captured by the microphone 613 and returned back though the speaker 633. In order to solve the problem of delayed return signal, each user may have an individual processor, namely processor 640 for user #1, processor 650 for user #2, and processor 660 for user #3. Similar to the configuration shown in FIG. 5, each processor may include a signal remover, a signal mixer, a measuring unit and an amplifier: signal remover 641, signal mixer 642, and amplifier 643 for processor 640; signal remover 651, signal mixer 652, and amplifier 653 for processor 650; and signal remover 661, signal mixer 662, and amplifier 663 for processor 660, respectively.

In detail, captured voices from the three users may be served as original audio signals 601, 602, and 603, respectively and may be input by the corresponding microphones 610, 620 and 630. During the transmission, delayed audio signals 601a, 602a, and 603a or delayed and amplified audio signals 601b, 602b, and 603b may be input to the recording system 620 which may be then mixed with a playback signal 604 by a mixer (not shown in FIG. 6) in the recording system 620. In some embodiments, the mix signal 604 may be a live-recorded or live-streamed signal mixing all audio signals from users #1, user #2 and user #3. The recording system 620 may then output a first processed signal 605 which is a mix of the mix signal 604 and the delayed signals 601b, 602b, and 603b. The first processed signal 605 may then be directed to each processor of processors 640, 650 and 660.

Similar to the configuration shown in FIG. 5, the processors 640, 650 and 660 each may remove the delayed signals 601a, 602b, and 603c or the delayed and amplified signals 601b, 602b, and 603b to generate second processed signals 606, 607 and 608. The processors 640, 650 and 660 each may also adjust the volume or frequency level of the original audio signals 601, 602, and 603 through the amplifiers 643, 653, and 663 according to the measured volume or frequency level of the delayed audio signal, rather than directly pulling-in the original audio signal 601, 602 and 603. The signal mixers 642, 652 and 662 in the processors 640, 650 and 660 may then be configured to mix the adjusted original audio signal and the processed signal 606, 607 and 608, and as a result, to generate third processed signals 621, 622, and 623 to be returned back to user #1, user #2, and user #3 through the speakers 631, 632, and 633, respectively. Therefore, an effective sidetone may be introduced that imitate the volume or frequency level of the user's voice in the mixed audio signal, which gives the user a feedback to how he/she sound in the mixed audio from multiple users.

The audio processors 340, 440, 540, or the set of audio processors including audio processors 640, 650 and 660 according to the present disclosure may be incorporated into any audio device, computer-implemented system or product. In some embodiments, a headset may be configured to include the audio processing mechanism according to the present disclosure. The headset may be configured to include a speaker and a microphone according to the present disclosure.

Having described above several aspects of at least one embodiment, it is to be appreciated various alterations, modifications, and improvements will readily occur to those skilled in the art. Such alterations, modifications, and improvements are intended to be part of this disclosure and are intended to be within the scope of the invention. Accordingly, the foregoing description and drawings are by way of example only, and the scope of the invention should be determined from proper construction of the appended claims, and their equivalents.

What is claimed is:

1. An audio processor for generating a non-delayed sidetone for a user, the audio processor comprising:
an input for receiving a playback signal, the playback signal including respective delayed audio signals from one or more users mixed together as the playback signal, the one or more users including a first user and the mixed audio signal from the first user being a delayed input audio signal;
a signal remover configured to generate a first processed signal by removing the delayed audio signal for the first user from the playback signal; and
a signal mixer coupled to the signal remover, the signal mixer configured to
generate a second processed signal by mixing the first processed signal with a non-delayed input audio signal from the first user, and
output the second processed signal, the non-delayed input audio signal acting as a sidetone for the first user.

2. The audio processor according to claim 1 further comprising a measuring unit coupled to the signal remover, the measuring unit configured to determine an audio feature of the delayed audio signal of the first user relative to the playback audio signal or relative to the non-delayed input audio signal from the first user.

3. The audio processor according to claim 2 further comprising a first amplifier having a first input, a second input, and an output, wherein the first input of the amplifier is coupled to the measuring unit and the second input of the amplifier is coupled to the non-delayed input audio signal from the first user, the output of the amplifier being coupled to the signal mixer such that the audio feature of the non-delayed input audio signal is adjusted based on a relative level of the determined audio feature of the delayed audio signal with respect to the playback audio signal.

4. The audio processor according to claim 3 wherein the determined audio feature is a volume or a frequency of the delayed audio signal.

5. The audio processor according to claim 1 further comprising a microphone coupled to the audio processor, the microphone being configured to input audio signals from the first user.

6. The audio processor according to claim 5 further comprising a speaker coupled to the audio processor, the speaker being configured to output the second processed audio signal to the first user.

7. The audio processor according to claim 6 further comprising an analog-to-digital converter coupled to the microphone.

8. The audio processor according to claim 7 further comprising a digital-to-analog converter coupled to the speaker.

9. An audio processing system for generating a non-delayed sidetone for a plurality of users, the audio processor system comprising for each respective user of the plurality of users:
an input configured to receive a playback signal including delayed audio signals from the plurality of users mixed together as the playback signal;
a signal remover, coupled to the input, the signal remover being configured to generate a first processed signal by removing the delayed audio signal for the respective user from the playback signal; and
a signal mixer, the signal mixer being coupled to the signal remover, the signal mixer configured to
generate a second processed signal by mixing the first processed signal with a non-delayed input audio signal from the respective user, and
output the second processed signal, the non-delayed input audio signal acting as a sidetone for the respective user.

10. A computer-implemented system comprising the audio processor of claim 1 and a recording device coupled to the audio processor, the recording device being configured to generate the playback signal input to the audio processor device.

11. The computer-implemented system according to claim 10 further comprising a second amplifier in the recording device for adjusting an audio feature of the delayed input audio signal in the mixed playback signal.

12. An audio processing method for generating a non-delayed sidetone for a user, the audio processing method comprising:
receiving a playback signal, the playback signal including respective delayed audio signals from one or more users mixed together as the playback signal, the one or more users including a first user and the mixed audio signal from the first user being a delayed input audio signal;
generating, by a signal remover, a first processed signal by removing the delayed audio signal for the first user from the playback signal;
generating, by a signal mixer, a second processed signal by mixing the first processed signal with a non-delayed input audio signal from the first user; and
outputting, by the signal mixer, the second processed signal, the non-delayed input audio signal acting as a sidetone for the first user.

13. The method according to claim 12 further comprising determining, by a measuring unit, an audio feature of the delayed audio signal of the first user relative to the playback audio signal or relative to the non-delayed input audio signal from the first user.

14. The method according to claim 13 further comprising adjusting, by a first amplifier, the audio feature of the non-delayed input audio signal based on a relative level to the playback signal, wherein a first input of the first amplifier is coupled to the measuring unit and a second input of the first amplifier is coupled to the non-delayed input audio signal from the first user, and an output of the first amplifier is coupled to the signal mixer.

15. The method according to claim 14 wherein the audio feature is a volume or a frequency of the delayed audio signal.

16. The method according to claim 12 further comprising inputting, by a microphone, an input audio signal from the first user.

17. The method according to claim 16 further comprising outputting, by a speaker, the second processed audio signal to the first user.

18. The method according to claim 17 further comprising coupling an analog-to-digital converter to the microphone and coupling a digital-to-analog converter to the speaker.

19. The method according to claim 14 further comprising adjusting, by a second amplifier, an audio feature of the delayed input audio signal in the mixed playback signal.

20. The method according to claim 12 further comprising generating, by a recording device, the playback signal.
